(19) United States
(12) Patent Application Publication
(10) Pub. No.: US 2022/0228039 A1
(43) Pub. Date: Jul. 21, 2022

(54) REPOSITIONABLE ADHESIVE SHEETS WITH PYRAMIDAL STRUCTURES

(71) Applicant: 3M INNOVATIVE PROPERTIES COMPANY, St. Paul, MN (US)

(72) Inventors: Ikuse Nomoto, Tokyo (JP); Haruyuki Mikami, Shizuoka (JP)

(21) Appl. No.: 17/595,774

(22) PCT Filed: May 22, 2020
(86) PCT No.: PCT/IB2020/054907

§ 371 Date: Nov. 24, 2021

(30) Foreign Application Priority Data
May 31, 2019 (JP) 2019-102936

(51) Int. Cl. C09J 7/40; C09J 7/38

(52) U.S. Cl. CPC C09J 7/403; C09J 7/385; C09J 2203/37; C09J 2475/00; C09J 2301/206; C09J 2301/302; C09J 2433/00; C09J 2301/204

(57) ABSTRACT

An adhesive sheet includes an adhesive layer having a fine structure on the surface. The fine structure includes a plurality of convex structures. The convex structures each have two or more parts. A first part located at the top portion of the convex structure is made from a non-adhesive or weak adhesive material. A second part located below the first part is made from a strong adhesive material. Given that a width of a bottom surface of the convex structure is a and a distance between bottom surfaces of adjacent convex structures is β in an arrangement direction of the convex structures, β/(α+β)<0.3 is satisfied.

### TECHNICAL FIELD

The present disclosure relates to an adhesive sheet.

### BACKGROUND

Adhesive sheets provided with a pressure sensitive adhesive surface are difficult to apply to a desired position because adhesiveness is exhibited by just slight contact of the pressure sensitive adhesive surface with the adherend. In order to solve the problem, it has been attempted to provide a pressure sensitive adhesive surface that does not adhere to an adherend and can be positioned by sliding it under low pressure (i.e., has slidability), while can exert a sufficient adhesive force under a pressure above a certain level. For example, Patent Document 1 discloses “an adhesive sheet having an adhesive layer and at least one topologically micro-structured surface obtained by coating the adhesive with its own contour structure or particles and underlying adhesive such that the adhesive layer has at least two stages of adhesion”.

### CITATION LIST

[Patent Document 1] JP 2000-500514 A

### SUMMARY

However, with the adhesive sheet described above, the slidability cannot be sufficiently high, and after the surface on which the plurality of protrusions are provided at a high pressure is applied to an adherend, air bubbles that are visible between the adherend and the adhesive sheet may remain. From an aspect of the present disclosure, an adhesive sheet with high slidability and less visible air bubbles is provided.

### SOLUTION TO PROBLEM

An adhesive sheet according to the present disclosure is an adhesive layer with a fine structure on a surface thereof, wherein the fine structure includes a plurality of convex structures, the convex structures each include two or more parts, a first part located at a top part of the convex structure is made from a non-adhesive or weak adhesive material, and a second part located below the first part is made from a strong adhesive material, and given that a width of a bottom surface of the convex structure is α and a distance between bottom surfaces of the adjacent convex structures is β in an arrangement direction of the convex structures, β/(α+β)<0.3 is satisfied.

The static friction coefficient as tested according to JIS K 7125 except that a slip piece made of metal is pulled at a rate of 1000 mm/min may be 10 or less.

The two or more portions may be joined to each other via an interface.

Given that a height of the convex structure is 100%, a height of the first part may be in a range of 10% to 90% of the height of the convex structure.

An angle θ formed between the side surface and the bottom surface of the convex structure may be 5 degrees or greater.

The height of the convex structure may be 5μm or greater.

The adhesive sheet may further comprise a liner disposed on the fine structure.

In a holding power test on an adhesive surface having a width of 12 mm and a length of 25 mm in accordance with JIS Z 0237: 2009, a retention time may be 5000 minutes or more.

The second part may include an acrylic foam. The fine structure may be provided on both surfaces of the adhesive layer.

### ADVANTAGEOUS EFFECTS OF INVENTION

According to the present disclosure, an adhesive sheet with high slidability and less visible air bubbles can be provided.

### BRIEF DESCRIPTION OF THE DRAWINGS

FIG. 1 is a perspective view of an adhesive sheet according to an embodiment.

FIG. 2 is a cross-sectional view taken along a line II-II in FIG. 1.

FIG. 3 is a cross-sectional view of an adhesive sheet according to another embodiment.

FIG. 4 is a cross-sectional view of an adhesive sheet according to another embodiment.

FIG. 5 is a partial cross-sectional view of an adhesive sheet according to another embodiment.

FIG. 6 are cross-sectional views illustrating other examples of the cone structure.

FIG. 7 are cross-sectional views illustrating other examples of the truncated cone structure.

FIG. 8 is a perspective view of an adhesive sheet according to an embodiment.

FIG. 9 are cross-sectional views illustrating steps in a method of manufacturing the adhesive sheet in FIG. 3.

FIG. 10 are cross-sectional views illustrating steps following the steps in FIG. 9.

FIG. 11 are cross-sectional views illustrating steps following the steps in FIG. 10.

FIG. 12 are cross-sectional views illustrating a step of applying the adhesive sheet in FIG. 3 to an adherend.

### DETAILED DESCRIPTION

Detailed description of the embodiments of the present disclosure will be given below with reference to the attached drawings. In the description of the drawings, identical or equivalent elements are denoted by the same reference signs, and redundant description of such elements will be omitted. The XYZ Cartesian coordinate system is illustrated in the drawings as necessary.

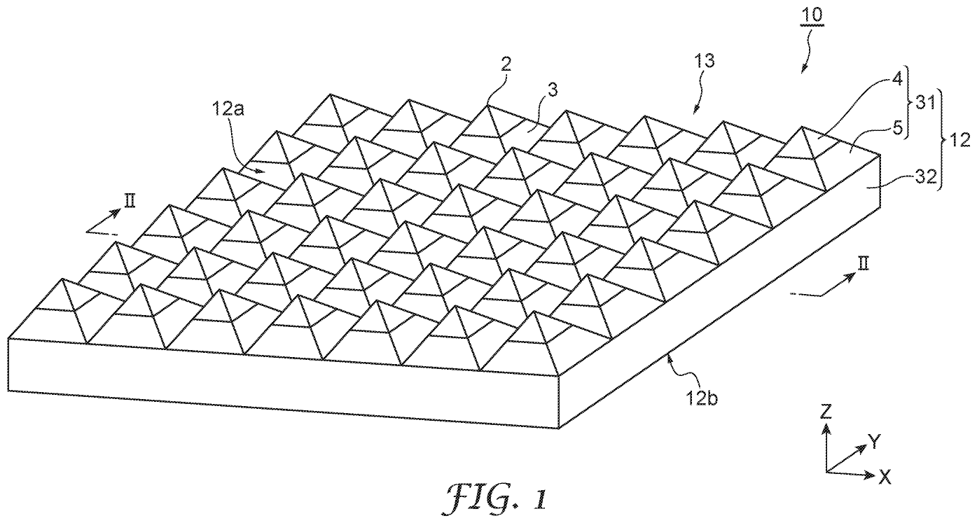

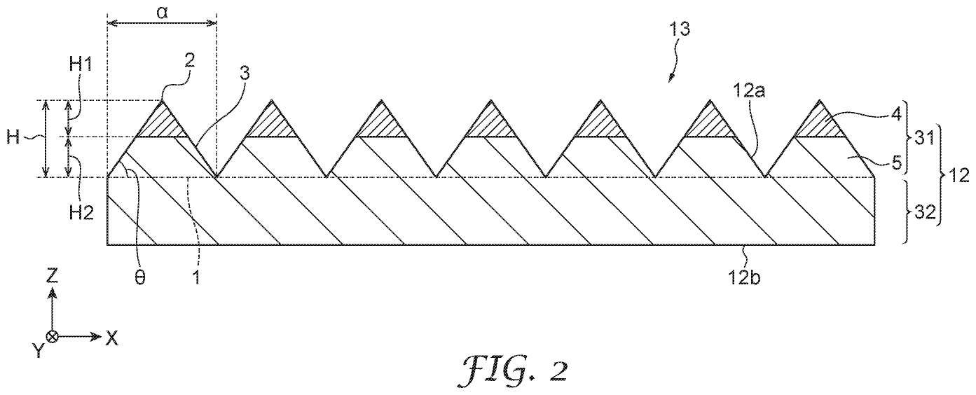

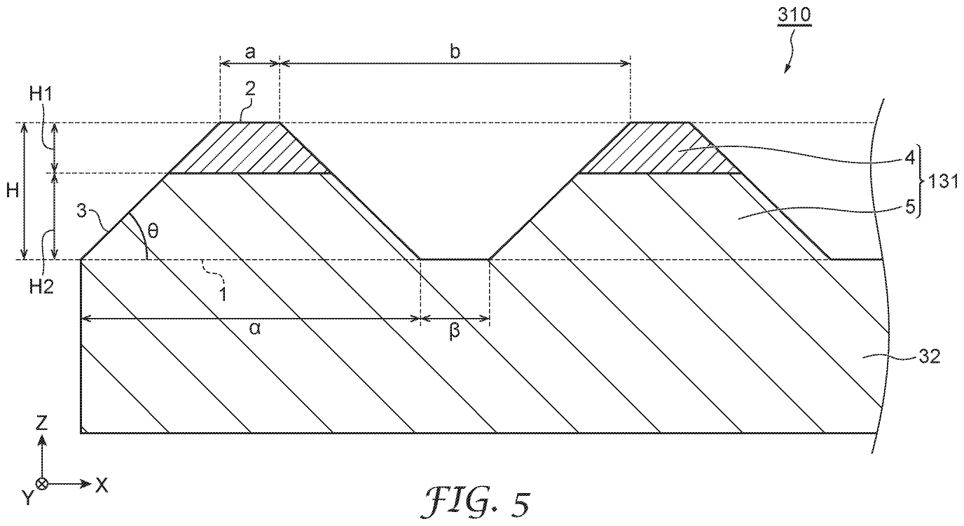

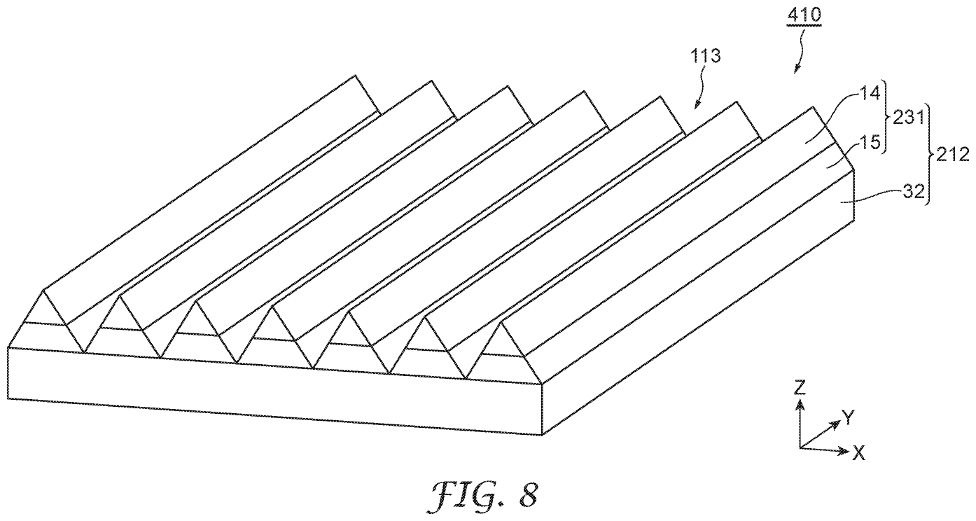

FIG. 1 is a perspective view of an adhesive sheet according to an embodiment. FIG. 2 is a cross-sectional view taken along line II-II in FIG. 1. The adhesive sheet 10 illustrated in FIGS. 1 and 2 has an adhesive layer 12. In the present embodiment, the adhesive layer 12 has a fine structure 13 on one surface 12a, and has no fine structure on the other surface 12b. The surface 12a and the surface 12b extend along a plane (for example, an XY plane) orthogonal to the thickness direction (for example, Z-axis direction) of the adhesive layer 12. The fine structure 13 includes a plurality of cone structures 31. The cone structures 31 can be replaced with truncated cone structures 131 (FIG. 5) or rib structures 231 (FIG. 8) described below. The cone structures 31, the truncated cone structures 131, and the rib structures 231 each are an example of a convex structure (convection body). Herein, the “convex structure” is generally a solid figure that includes any plane figure as a bottom surface, and that is constituted by connecting all points in sides of the bottom surface and all points in sides of any other plane figure or any straight line (top part). Preferably, the area of the top part of the convex structure is smaller than the area of the bottom surface. More preferably, the convex structure has a shape that tapers from the bottom surface to the top part. The plurality of cone structures 31 are arranged in a lattice pattern on the surface 12a in the X-axis direction and the Y-axis direction. FIG. 2 is a cross-sectional view taken along apexes of a plurality of cone structures 31 arranged in the X-axis direction. Preferably, the plurality of cone structures 31 can be regularly or irregularly arranged on a plane. The area of the cone structure 31 projected on the plane orthogonal to the height direction of the cone structure 31 (area of the bottom surface 1 of the cone structure 31) may be 10 μm or greater, and may be 10000 μm or less.

Each cone structure 31 has a bottom surface 1, a top part 2, and a plurality of side surfaces 3 connecting the edges of the bottom surface 1 to the top part 2. The bottom surface 1 has any planar shape such as a circle (including an ellipse) or a polygon. Examples of the shape of the cone structure 31 include a cone, a triangular cone, a quadrangular cone, and a hexagonal cone. In the example illustrated in FIGS. 1 and 2, the shape of the cone structure 31 is a quadrangular cone. The shape of the respective cone structures 31 may be the same or different. The cone structures preferably have substantially the same height (for example, a difference in height is within ±5%, ±3%, or ±1%), and more preferably have substantially the same shape. When the cone structures 31 of different shapes are present, the fine structure 13 is preferably configured of 10 or less, 9 or less, 8 or less, 7 or less, 6 or less, 5 or less, 4 or less, 3 or less, or 2 or less types of cone structures 31. Two or more of the cone structure 31, the truncated cone structure 131 (FIG. 5) and the rib structure 231 (FIG. 8) may coexist.

The cone structures 31 each include a first part 4 located on the top part 2 of the cone structure 31 and a second part 5 located below the first part 4 (on the bottom surface 1 side). The top part 2 means a part that substantially occupies a region located at the highest position of the cone structure 31 (the part in the cone structure 31, which first comes contact with the adherend when the adhesive sheet of the present disclosure approaches the adherend). The top part 2 preferably includes the apex of the cone structure 31. The “substantially occupying” means that the case where a different material is attached to or incorporated in only a portion is also included. For example, the first part 4 may occupy a majority (for example, 90% or greater, or 95% or greater) of the highest region of the cone structure 31. Even when a small amount of filler or the like is included in the region, the filler or the like does not correspond to the first part 4. The first part 4 supports the adhesive sheet 10 when the pressure applied to the adhesive sheet 10 is low, thereby imparting slidability to the adhesive sheet 10. When a pressure applied to the adhesive sheet 10 becomes a certain value or more, the second part 5 contacts with the adherend due to, for example, deformation of the second part 5 itself, deformation of the first part 4, or incorporation of the first part 4 into the second part 5, and develops adhesiveness.

The first part 4 and the second part 5 may be joined to one another via an interface, for example, along an XY plane. The being “joined via an interface” means that two matrix phases having different kinds of composition are in contact via a distinct interface.

For example, the first part 4 (matrix phase) and the second part 5 (matrix phase) are layered and separated as illustrated in FIGS. 1 and 2 and thus are joined via the interface. Note that for example, in the case of a composition in which fine particles are dispersed in a resin, the resin serving as a substrate corresponds to the matrix phase, while the fine particles correspond to a dispersed phase. The joining via an interface does not include joining of two phases including a common matrix phase and different dispersed phases, or a joining manner in which a material varies continuously, for example, in a material in which fine particles are dispersed in a resin, only density of the fine particles continuously varies in a direction. The interface may be a flat surface that is parallel or not parallel to the bottom surface of the cone structure 31. The interface may have a surface curved due to, for example, a manufacturing error or surface tension in a manufacturing method described below. The cone structure 31 may optionally further include a third portion, or may have a multilayer structure including three or more layers.

The first part 4 is made of a non-adhesive or weak adhesive material. The non-adhesive or weak adhesive material preferably has no adhesiveness to an adherend, or has adhesiveness but can be re-peeled easily from the adherend. In an embodiment, the non-adhesive or weak adhesive material is a resin having a storage elastic modulus (G′) calculated by dynamic viscoelasticity measurement of 3×10⁵ Pa or greater, 4×10⁵ Pa or greater, 5×10⁵ Pa or greater, 6×10⁵ Pa or greater, 7×10⁵ Pa or greater, 8×10⁵ Pa or greater, 9×10⁵ Pa or greater, or 1×10⁶ or greater as measured at a frequency of 1 Hz and at normal temperature. Specific examples include polyurethane, poly (meth)acrylate, cellulose, silicone, an amine-based resin, a fluorine-based resin, and polyvinyl chloride. The non-adhesive or weak adhesive material preferably has a static friction coefficient of 10 or less, 7 or less, 5 or less, 4 or less, or 3 or less as tested according to JIS K 7125 except that a metal slip piece such as a steel material (for example, an SS400 material, may be plated with chrome or the like) is pulled at a rate of 1000 mm/min. The non-adhesive or weak adhesive material preferably has high solubility and/or dispersibility in any general purpose solvent of a water miscible solvent such as water or alcohol, or a water immiscible solvent such as hydrocarbon. Additionally, a solvent in which the non-adhesive or weak adhesive material dissolves and/or disperses preferably has a relatively low vapor pressure and is easy to dry. Further, wettability to a mold for forming the fine structure 13 is preferably also considered. When the wettability is too low, the solvent may not completely enter into recesses of the mold, and when the wettability is too high, the solvent may remain between the recesses of the molds.

The second part 5 is made of a strong adhesive material. A known material used in manufacturing of a pressure sensitive adhesive can be used as the strong adhesive material. A material that exhibits a relatively strong adhesive force to an adherend, and cannot not easily peeled again is preferable. In an embodiment, the strong adhesive material can be defined as a material that meets the so-called Dahlquist criterion, specifically a condition where the storage elastic modulus (G′) obtained by measuring at normal temperature and a frequency of 1 Hz is less than about 3×10⁵ Pa. Specific examples include an acrylic adhesive, a rubber-based adhesive, or a silicone-based adhesive, and a foam tape (polyurethan foam, polyurethane foam, and the like) using such adhesive as an adhesive layer. For example, the acrylic adhesive foam (acrylic foam) exhibits an adhesive force to the surface and a strong adhesive force due to the stress dispersion effect of the soft acrylic foam, as well as exhibit deformation trackability, vibration absorbing properties, sealing effects, and weather resistance. In the strong adhesive material, a tackifier may be blended.

The average diameter of the air bubbles contained in the acrylic foam is preferably from 5 to 300 μm, and more preferably from 5 to 200 μm. The acrylic foam containing such bubbles has even better flexibility and curved surface trackability. The content of air bubbles in the acrylic foam is preferably from 5 to 40 volume % based on the total volume of the acrylic foam, and more preferably from 5 to 30 volume %. When the content of the air bubbles is less than the lower limit described above, the flexibility of the acrylic foam may decrease, and when the content of the air bubbles is larger than the upper limit described above, the strength of the acrylic foam may decrease. That is, by setting the content of the air bubbles to be within the range described above, both of flexibility and strength of the acrylic foam can be achieved. The density of the acrylic foam is preferably 0.3 g/cm³ or greater, and more preferably 0.5 g/cm³ or greater. Further, the density of the acrylic foam is preferably 2.0 g/cm³ or less, and more preferably 1.5 g/cm³. When the density of the acrylic foam is within the range described above, both flexibility and strength are good.

All of the non-adhesive or weak adhesive material, and the strong adhesive material preferably have hardness of a certain level or more to maintain the fine structure 13. For example, a material having a tan δ of 0.8 or less, 0.7 or less, 0.6 or less, 0.5 or less, 0.4 or less, or 0.3 or less as measured at normal temperature and a frequency of 1 Hz is preferable.

Note that “non-adhesive,” “weak adhesive,” and “strong adhesive” mean the relative adhesive strength with respect to the same adherend. Adhesiveness can be evaluated by a known technique such as dynamic viscoelasticity measurement or a 180-degree peel strength test.

A combination of the material of the first part 4 and the material of the second part 5 is not limited, but materials are more preferably selected in consideration of adhesive force between the first part and the second part. For example, in terms of affinity of the polymer structure and the like, when the material of the first part 4 is silicone, the material of the second part 5 is also preferably a silicone-based adhesive. However, the material of the first part 4 and the material of the second part 5 are not necessarily polymers having the same structure.

The adhesive layer 12 may have a base 32 in a portion below the plurality of cone structures 31. The base 32 is joined or continuous with the bottom surface 1 of the cone structures 31 of the fine structure 13. A material for the base 32 may be the same as or different from the material for the second part 5. In one embodiment, the cone structure 31 is constituted of two portions of the first part 4 and the second part 5, and the base 32 is formed from the same material as the material for second part 5, and is continuous with the second part 5. The thickness of the base 32 may be arbitrarily set depending on the desired thickness of the adhesive layer 12. When the material of the base 32 is elastic, the cone structures 31 in the fine structure 13 can sink into the base 32 and therefore, the second parts 5 of the cone structures 31 easily contact with the adherend, thereby improving adhesiveness of the adhesive sheet 10.

When all of the non-adhesive or weak adhesive material constituting the first part 4, the strong adhesive material constituting the second part 5, and if any, materials constituting the other portions are transparent, the entire adhesive layer 12 can be made transparent. At that time, to make the interface via which the parts are joined invisible, a difference in a refractive index among the materials constituting these parts is preferably within 1%. Specifically, when the first part 4 and the second part 5 of the cone structure 31 are adjacent to each other, and the difference between the refractive index of the material constituting the first part 4 and the refractive index of the material constituting the second part 5 is within 1%, 0.9%, 0.8%, 0.7%, or 0.6%, the interface between the two portions is generally not visible. For example, when the first part 4 is formed from a transparent acrylic resin and the second part 5 is formed from a transparent acrylic adhesive, the above-described requirement is satisfied, and the completely-transparent adhesive layer can be provided. Note that transparent can be defined by, for example, haze of 40% or less as measured in accordance with JIS K 7136.

In terms of, for example, facilitating the formation of the first part 4, in the cone structures 31 included in the fine structure 13, the longest distance between the centers of two adjacent cone structures 31 may be 300 μm or less, 260 μm or less, 220 μm or less, 180 μm or less, 140 μm or less, or 100 μm or less. Note that the center of the cone structure 31 refers to the apex of the cone. The center of the truncated cone structure 131 (FIG. 5) refers to the apex of the corresponding cone structure.

In terms of, for example, facilitating the formation of the first part 4, a width (corresponding to a described below) of the bottom surface 1 of the cone structure 31 in the arrangement direction of the cone structures 31 (for example, the X-axis direction) is 500 μm or less, 450 μm or less, 400 μm or less, 350 μm or less, 300 μm or less, 250 μm or less, 200 μm or less, 150 μm or less, 100 μm or less, 95 μm or less, 90 μm or less, 85 μm or less, 80 μm or less, 75 μm or less, 70 μm or less, 65 μm or less, 60 μm or less, 55 μm or less, or 50 μm or less.

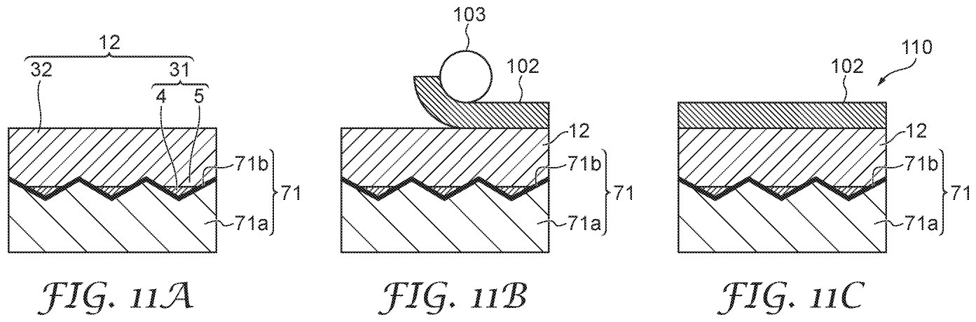

In terms of, for example, facilitating the production of the adhesive sheet 10, or facilitating the peeling of a liner 71 (see FIG. 11) from the finished adhesive sheet 10, a height H of the cone structure 31 is 5 μm or greater, and 100 μm or less, 95 μm or less, 90 μm or less, 85 μm or less, 80 μm or less, 75 μm or less, 70 μm or less, 65 μm or less, 60 μm or less, 55 μm or less, or 50 μm or less.

In terms of providing sufficient slidability, the number of cone structures 31 per 1 mm² of the surface of the adhesive layer 12 is preferably 16 or greater, 25 or greater, 36 or greater, 49 or greater, 64 or greater, 81 or greater, or 100 or greater. The number of the cone structures 31 corresponds to the number of the centers of the cone structures 31 that are present in the unit area. The high density of the cone structures 31 also contributes to improvement of slidability. The bottom surfaces 1 of two adjacent cone structures 31 may be proximate to each other. For example, in the case of a quadrangular cone or hexagonal cone, the bottom surfaces 1 of two adjacent cone structures 31 may share one side, or adjacent sides may be separated from each other by a distance (corresponding to β described below) of 250 μm or less, 200 μm or less, 150 μm or less, 100 μm or less, 50 μm or less, 15 μm or less, or 10 μm or less.

Given that the width of the bottom surface 1 of the cone structure 31 is a and the distance between the bottom surfaces 1 of adjacent cone structures 31 is β in the arrangement direction of the cone structures 31 (for example, the X-axis direction), β/(α+β)<0.3 is satisfied. β/(α+β)<0.2 may be satisfied, or β/(α+β)<0.1 may be satisfied. In the example of FIGS. 1 and 2, β is 0, so the value of β/(α+β) is 0. The plurality of cone structures 31 may be arranged with a distance β more than 0 between the bottom surfaces 1 of adjacent cone structures 31.

(α+β) corresponds to the pitch of adjacent cone structures 31. (α+β) may be not 10 μm or greater, 15 μm or greater, 20 μm or greater, 200 μm or greater, 150 μm or greater, or 100 μm or greater.

In terms of easiness of formation of the first part 4, slidability of the adhesive layer 12 or the like, an angle θ formed between the side surface 3 and the bottom surface 1 of the cone structure 31 may be 5 degrees or greater, 10 degrees or greater, 15 degrees or greater, 20 degrees or greater, or 25 degrees or greater in a cross-section (XZ plane) including the apexes of the cone structures 31 and the arrangement direction of the cone structures 31. Furthermore, in terms of smoothly releasing the adhesive sheet 10 from a liner 71 described below or the like, the angle θ may be less than 90 degrees, 85 degrees or less, 80 degrees or less, or 70 degrees or less in the cross-section (XZ plane) including the apexes of the cone structures 31 and the arrangement direction of the cone structures 31.

The height H of the cone structure 31 may be 5 μm or greater, 10 μm or greater, or 25 μm or less. Given that the height H of the cone structure 31 is 100%, in terms of slidability or the like, a height H1 of the first part 4 may be 10% or greater, 15% or greater, or 20% or greater of the height H of the cone structure 31. Furthermore, in terms of adhesive strength after crimping or the like, the height H1 may be 90% or less, 80% or less, 70% or less, 60% or less, or 50% or less of the height H. Note that the heights H, H1 are based on the normal direction (Z-axis direction) of the bottom surface 1 of the cone structure 31. When the interface between the first part 4 and the second part 5 located below the first part is a flat surface or a curved surface that is not parallel to the bottom surface 1, the height H1 is calculated from an average value of the heights of the interface as determined based on the normal direction of the bottom surface 1. When the first part 4 is relatively small, the adhesive sheet 10 has decreased slidability and increased frictional force, but tends to exhibit improved adhesive force when a pressure of a certain level or more is applied thereto. On the other hand, when the first part 4 is relatively large, the opposite is true.

The thickness of the adhesive layer 12 may be set as desired depending on the adhesive material used, the intended use of the adhesive sheet 10, or the like, and may be, for example, in the range of 15 μm to 10 mm or 200 μm to 4 mm. The thickness of the adhesive layer 12 refers to the distance between the highest portion of the cone structure 31 and the surface 12b that is opposite to the surface 12a having the fine structure 13, based on the normal direction of the bottom surface 1 of the cone structure 31.

The adhesive layer 12 may include an additional material other than an adhesive, for example, fine particles such as hollow or solid glass spheres for adjusting adhesiveness. However, the adhesive sheet 10 of the present disclosure can achieve the desired properties without including such additional materials. In an embodiment, the adhesive layer 12 includes no fine particle.

(Characteristics of Adhesive Sheet) The adhesive sheet 10 has sufficient slidability under low pressure, for example, when the pressure applied to the surface 12b of the adhesive layer 12 is 100 g/cm² or less, 50 g/cm² or less, 10 g/cm², or 5 g/cm² or less. In a preferred embodiment, the adhesive sheet 10 has a dynamic friction coefficient (μ_{D}) of 10 or less, 5 or less, or 3 or less as tested according to JIS K 7125, except that a slip piece made of metal such as a steel material (for example, an SS400 material that may be plated with chrome or the like) is pulled at a rate of 1000 mm/min. With such a low friction force, the adhesive sheet 10 can be easily slid and aligned while being in slight contact with the adherend.

The adhesive sheet 10 exhibits a sufficient adhesive force to the adherend when a relatively high pressure is applied to the surface 12b of the adhesive layer 12. In an embodiment, the “relatively high pressure” can be defined as a pressure corresponding to pressure generated by reciprocating once a roller of 2 kg at a rate of 300 mm/min by using a crimping device defined in 10.2.4 of JIS Z 0237: 2009. In another embodiment, the “relatively high pressure” can be defined as pressure of 200 g/cm² or greater, 300 g/cm² or greater, 400 g/cm² or greater, 500 g/cm² or greater, 600 g/cm² or greater, or 700 g/cm2 or greater. In a preferred embodiment, the adhesive sheet 10 has a 90-degree peel adhesive strength of 2 N/10 mm or greater, 4 N/10 mm or greater, 6 N/10 mm or greater, 8 N/10 mm or greater, or 10 N/10 mm or greater for a SUS plate after 24 hours of adhesion as tested under conditions of a temperature of 23° C. and a tension speed of 300 mm/min. When such an adhesive force is exerted, the adhesive sheet 10 scarcely causes peeling or the like after adhesion.

Since the adhesive sheet 10 has the fine structure 13 on the surface 12a of the adhesive layer 12, the adhesive surface traps few air bubbles when applied to the adherend, and can easily release possible entrapped bubbles. Such a property is herein referred to as “air releasability.” In an embodiment, the surface 12a of the adhesive layer 12 may further include an additional groove-shaped structure for improving air releasability, apart from the above-described fine structure 13.

In accordance with JIS Z 0237: 2009, in a holding power test on an adhesive surface with a width of 12 mm and a length of 25 mm, the retention time of the adhesive sheet 10 may be 5000 minutes or more. The holding power test follows JIS Z 0237: 2009 with an adhesive area of a width of 12 mm and a length of 25 mm. A 0.82 g SUS plate is attached to both of the surfaces 12a, 12b of the adhesive layer 12. The SUS plate is SUS304BA and has a width of 30 mm, a length of 60 mm, and a thickness of 0.5 mm. A test sample made of a pair of SUS plates and the adhesive sheet 10 therebetween is horizontally placed, a 1 kg weight is placed on the test sample, and the test sample is left for 15 minutes. As a result, the pair of SUS plates are crimped to the adhesive sheet 10. Next, the SUS plate attached to the surface 12a on which the fine structure 13 is provided is fixed with the test sample vertically standing. The test sample is left in this state for 10 minutes under a 90° C. atmosphere. Next, a 1 kg weight is vertically hung from the SUS plate attached to the surface 12b on the opposite side to the surface 12a on which the fine structure 13 is provided. A time taken from hanging of the weight to falling of the SUS plate with the weight is measured. A similar measurement is performed three times, and an average time is defined as the retention time of the adhesive sheet 10.

The static friction coefficient of the adhesive sheet 10 as tested according to JIS K 7125 except that the steel material is pulled at a rate of 1000 mm/min may be 10 or less or 5 or less. In this case, the adhesive sheet 10 has high slidability with respect to the adherend pressed with a low pressure.

As explained above, in the adhesive sheet 10, given that the width of the bottom surface 1 of the cone structure 31 is a and the distance between the bottom surfaces 1 of adjacent cone structures 31 is β in the arrangement direction of the cone structures 31 (for example, the X-axis direction), β/(α+β<0.3 is satisfied. Thus, the space between adjacent cone structures 31 is relatively small. Therefore, when the adhesive sheet 10 is applied to the adherend with a high pressure, excess air is hardly left between adjacent cone structures 31. Thus, after the adhesive sheet 10 is applied to the adherend with a high pressure, visible air bubbles are hardly left between the adhesive sheet 10 and the adherend. Furthermore, after the adhesive sheet 10 is applied to the adherend with a low pressure, the adhesive sheet 10 has high slidability with respect to the adherend.

When the angle θ formed between the side surface 3 and the bottom surface 1 of the cone structure 31 is 5 degrees or greater, the distance from the bottom surface 1 of the cone structure 31 to the adherend increases and thus, when the adhesive sheet 10 is pressed against the adherend with a low pressure, the second part 5 can be prevented from contacting the adherend with a wide area. Thus, after the adhesive sheet 10 is pressing against the adherend with a low pressure, the adhesive sheet 10 has even higher slidability relative to the adherend.

When the height H of the cone structure 31 is 5 μm or greater, the distance from the bottom surface 1 of the cone structure 31 to the adherend increases and thus, when the adhesive sheet 10 is pressed against the adherend with a low pressure, the second part 5 can be prevented from contacting the adherend with a wide area. Thus, after the adhesive sheet 10 is pressing against the adherend with a low pressure, the adhesive sheet 10 has even higher slidability relative to the adherend.

Given that the height H of the cone structure 31 is 100%, in the case where the height H1 of the first part 4 is in the range of 10% to 90% of the height H of the cone structure 31, the adhesive sheet 10 has a higher slidability relative to the adherend after the adhesive sheet 10 is pressed against the adherend with a low pressure, while the second part 5 can contact the adherend with a wide area when the adhesive sheet 10 is attached to the adherend with a high pressure.

Such adhesive sheets 10 can be applied to a variety of applications. High slidability is useful for applications where alignment is important. Further, air releasability is useful for applications where air bubbles are to be vented (to the extent visible) in terms of penetration or transmission of light, heat, electricity, etc. For example, in securing a wall material, a flooring material, a tile material, a sash material, a sign, a display panel, a battery cell, an on-board device, etc., both of slidability and air releasability may be required, and it is particularly useful to apply the adhesive sheet 10 to such applications. Also, high adhesive strength is often required in such applications. With all things considered, more preferably, an adhesive sheet with air releasability has a static friction coefficient of 10 or less or 5 or less in terms of slidability or the like, and a 90-degree peel strength after 24 hours of 4N/10 mm or greater or 10N/10 mm or greater in terms of adhesive force or the like. From this perspective, the angle θ may be 20 degrees or greater, the height H may be 10 μm or greater, and the ratio of the height H1 to the height H may be 15 to 50%.

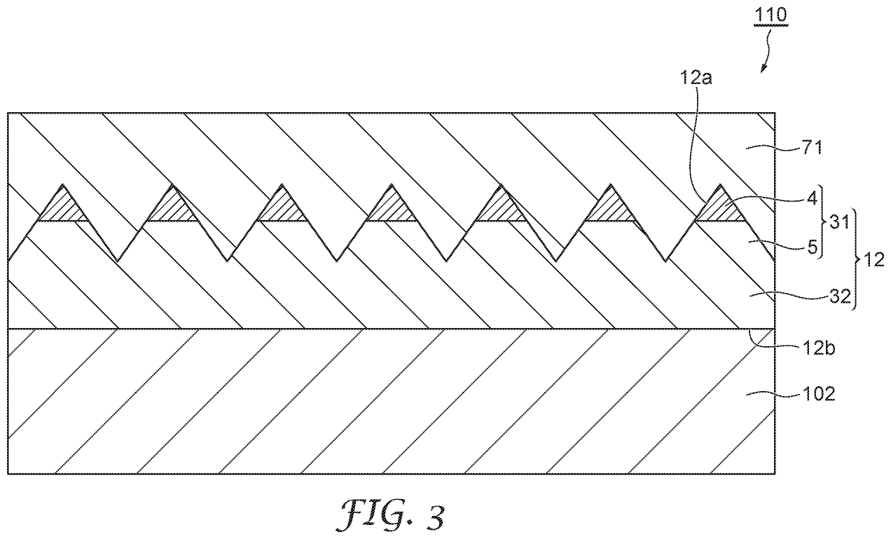

FIG. 3 is a cross-sectional view of an adhesive sheet according to another embodiment. An adhesive sheet 110 illustrated in FIG. 3 includes the adhesive layer 12 illustrated in FIGS. 1 and 2, a liner 71 disposed on the fine structure 13, and a carrier 102 provided on the surface 12b where no fine structure is provided. The liner 71 can protect the fine structure 13. The adhesive sheet 110 may not include any one of the liner 71 and the carrier 102. For example, when the adhesive sheet 110 does not include the carrier 102, a roll can be formed by winding the adhesive sheet 110 around a core such that the adhesive layer 12 is located on the inner side.

Examples of the carrier 102 include a resin film such as a film made from ABS, ASA, acrylic, polycarbonate, polyurethane, fluororesin, polypropylene, PET, or PVC. The use of an elastic carrier 102 such the acrylic foam enables the cone structures 31 of the fine structure 13 to sink into the carrier 102, such that the second parts 5 of the cone structures 31 easily contact with the adherend, improving adhesiveness of the adhesive sheet 110. The adhesive sheet 110 may has any layer containing a primer or the like between the carrier 102 and the adhesive layer 12.

Examples of the liner 71 include films made from a similar material to the material for the carrier 102.

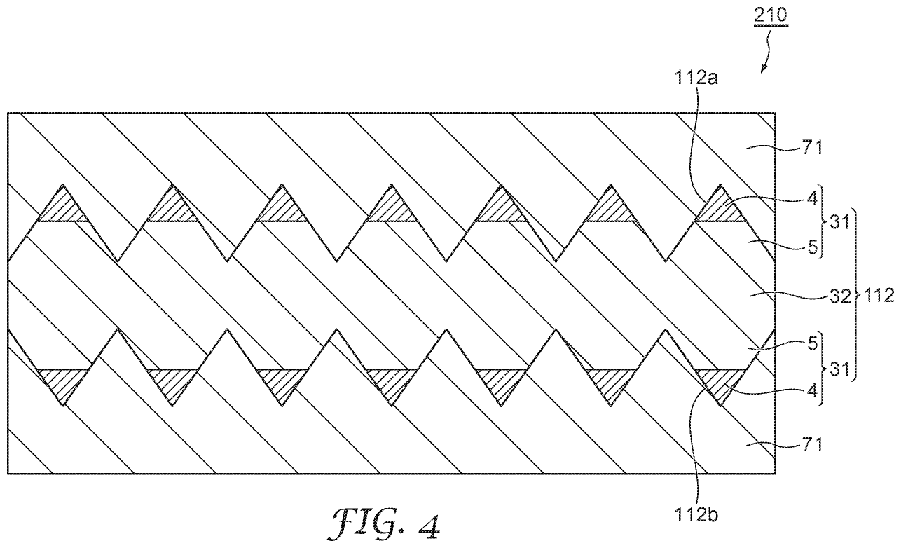

FIG. 4 is a cross-sectional view of an adhesive sheet according to another embodiment. An adhesive sheet 210 illustrated in FIG. 4 includes an adhesive layer 112 and a pair of liners 71 sandwiching the adhesive layer 112. The adhesive layer 112 has a configuration in which the fine structure 13 is provided on the surface 12b of the adhesive layer 12 in FIGS. 1 and 2. Thus, the fine structure 13 is provided on each of the surfaces 112a, 112b of the adhesive layer 112. The fine structures 13 provided on the surfaces 112a, 112b may have the same structure as each other or may have different structures from each other. For example, on the surfaces 112a, 112b, the material or height H1 of the first part 4 may be the same or different.

FIG. 5 is a partial cross-sectional view of an adhesive sheet according to another embodiment. An adhesive sheet 310 illustrated in FIG. 5 includes a plurality of truncated cone structures 131 instead of the plurality of cone structures 31, and has the same configuration as the adhesive sheet 10 except that the plurality of cone structures 131 are spaced in the arrangement direction. Each of the truncated cone structures 131 has the structure of the cone structure 31 with the top portion including the apex of the cone structure 31 removed. Examples of the shape of the truncated cone structure 131 include truncated cone, truncated triangular cone, truncated quadrangular cone, and truncated hexagonal cone. Each of the truncated cone structures 131 includes a first part 4 located at a top portion 2 of the truncated cone structure 131 and a second part 5 located below the first part 4 (on the bottom surface 1 side).

In this embodiment, given that the width of the bottom surface 1 of the truncated cone structure 131 is a and the distance between the bottom surfaces 1 of adjacent truncated cone structures 131 is β in the arrangement direction of the truncated cone structures 131 (for example, the X-axis direction), β/(α+β)<0.3 is satisfied. In the example of FIG. 5, β is larger than 0, but β may be 0. In the arrangement direction of the truncated cone structures 131, the width of the top surface of the truncated cone structure 131 is a and a distance between the top surfaces of adjacent truncated cone structures 131 is b. When a is 0, the truncated cone structure 131 has the same structure as the cone structure 31.

The width a of the top surface of the truncated cone structure 131 in the arrangement direction of the truncated cone structures 131 is, for example, 50 μm or less, 40 μm or less, 30 μm or less, 20 μm or less, or 10 μm or less. A decrease in the adhesive force exerted under a pressure of a certain level or more can be prevented by making the width a of the top surface to the width a of the bottom surface 1 not too large.

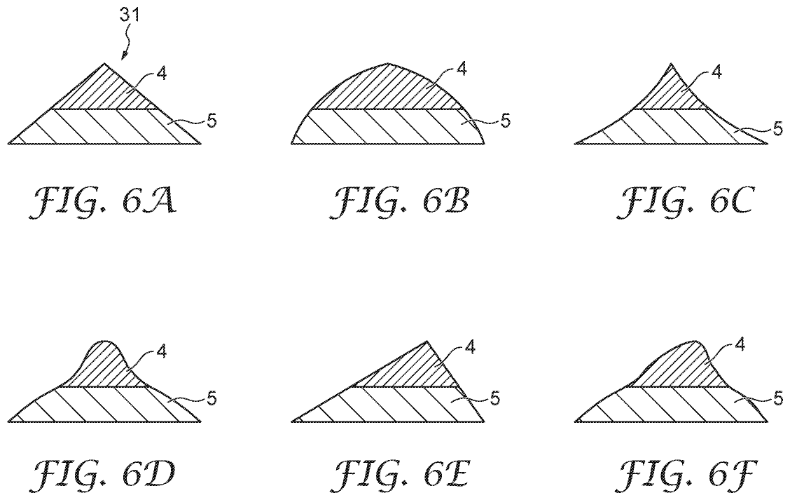

FIG. 6 are cross-sectional views illustrating other examples of the cone structure. The cross-section of the cone structure 31 may be triangular as illustrated in FIG. 6(a), may have a distorted side surface illustrated in FIGS. 6(b) to 6(d), or may be shaped such that have the apex is off the center of the bottom surface as illustrated in FIG. 6(e). As illustrated in FIG. 6(f), the cross section of the cone structure 31 may have a distorted side surface and the apex that is off the center of the bottom surface. Note that all the cross sections passing through the apex of the cone structure 31 do not necessarily have the same shape, and may have different shapes.

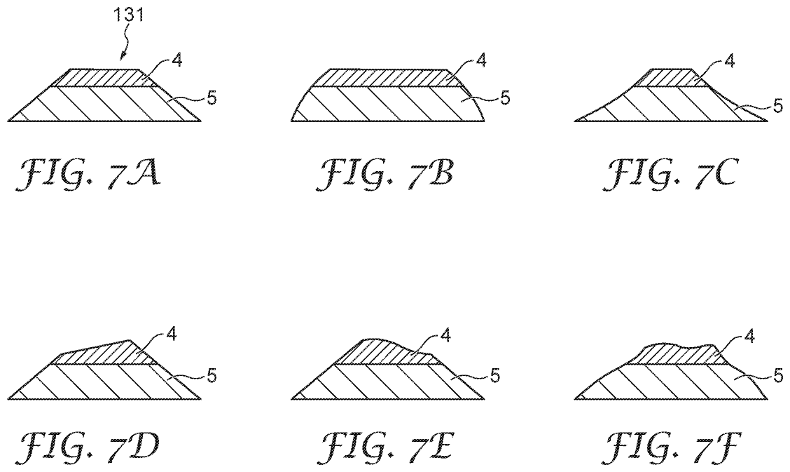

FIG. 7 are cross-sectional views illustrating other examples of the truncated cone structure. The cross-section of the truncated cone structure 131 may be trapezoidal as illustrated in FIG. 7(a), may have a distorted side surface as illustrated in FIGS. 7(b) and 7(c), or may have a distorted top surface as illustrated in FIGS. 7(d) to 7(e). As illustrated in FIG. 7(f), the cross-section of the truncated cone structure 131 may have a distorted side surface and a distorted top surface. Note that all the cross sections passing through the apex of the truncated cone structure 131 do not necessarily have the same shape, and may have different shapes. Additionally, the top surface of the truncated cone structure 131 may not be parallel to a bottom surface or may not be planar.

FIG. 8 is a perspective view of an adhesive sheet according to an embodiment. The adhesive sheet 410 illustrated in FIG. 8 has the same configuration as the adhesive sheet 10 in FIG. 1 except that a plurality of rib structures 231 instead of a plurality of cone structures 31 are provided. An adhesive sheet 410 includes an adhesive layer 212 having a fine structure 113 that includes the plurality of rib structures 231. The plurality of rib structures 231 are arranged in the X-axis direction, and each of the rib structures 231 extends in the Y-axis direction. The rib structures 231 each include a first part 14 that is present at the top portion of the rib structure 231 and a second part 15 located below the first part 14 (the bottom surface side). The cross section of the adhesive sheet 410, which is orthogonal to the Y-axis direction, is the same as the cross section of the adhesive sheet 10 illustrated in FIG. 2.

The rib structure 231 is a solid figure that includes, as a bottom surface, a plane figure structured such that a length in any axial direction (Y-axis direction) on a plane is greater than a length in an axial direction (X-axis direction) orthogonal to the x axis, and that is constituted by connecting all points in sides of the bottom surface and all points in lines or sides of a rectangle extending on the other plane in a direction substantially parallel to the Y-axis direction. A cross section of the rib structure 231, like the cone structure 31 and the truncated cone structure 131, may have any shape as illustrated in FIGS. 6(a) to 6(f) and FIGS. 7(a) to 7(f). A ratio of the length in the Y-axis direction to the length in the X-axis direction of the bottom surface of the rib structure 231, that is, an aspect ratio is, for example, 2 or greater, 3 or greater, 4 or greater, 5 or greater, 10 or greater, 50 or greater, 100 or greater, 500 or greater, 1000 or greater, or 10000 or greater. The rib structure 231 may be continuously formed along any axial direction across the entire surface of the adhesive sheet 410.

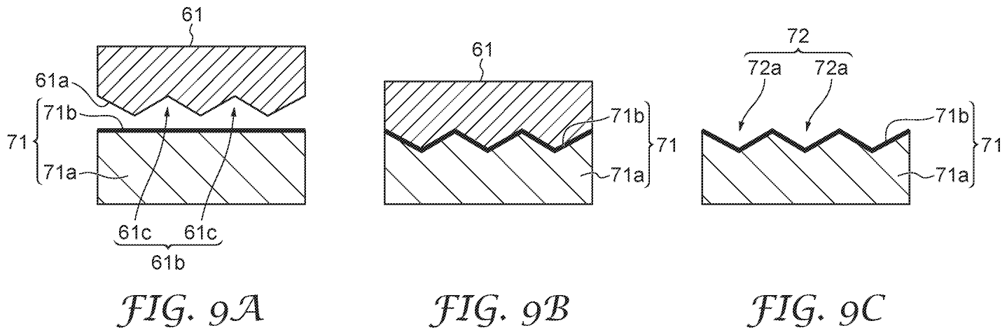

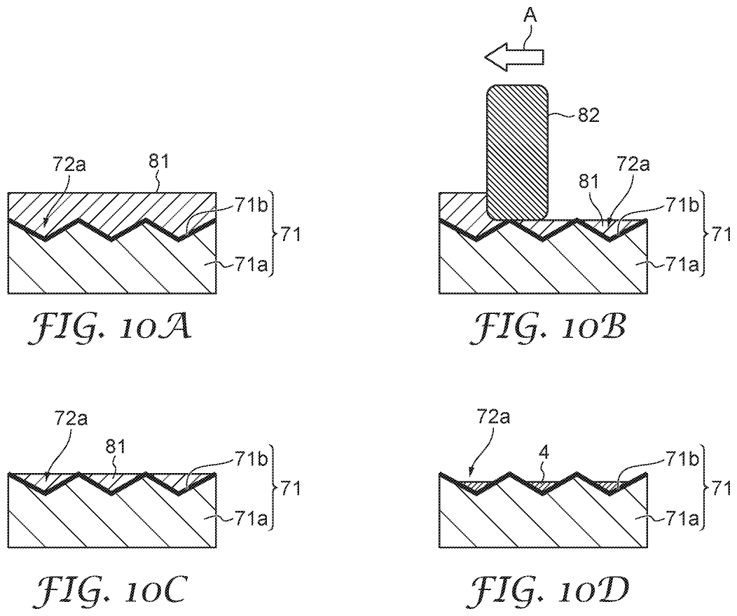

FIG. 9 are cross-sectional views illustrating steps in a method of manufacturing the adhesive sheet in FIG. 3. FIG. 10 are cross-sectionals view illustrating steps following the steps in FIG. 9. FIG. 11 are cross-sectionals view illustrating steps following the steps in FIG. 10. The adhesive sheet 110 in FIG. 3 may be manufactured by, for example, following steps.

### (Mold Preparing Step)

First, as illustrated in FIG. 9(a), a mold 61 is prepared. The mold 61 has a fine structure 61b on the surface 61a. The fine structure 61b comprises a plurality of cone structures 61c. A mold 61 can be produced by machining a flat plate made from a material such as a metal or a resin using a diamond cutter or a laser. The cone structure 61c has substantially the same shape as the cone structure 31 of the adhesive sheet 110. A difference in the size between the cone structure 61c and the cone structure 31 is preferably within ±5%, within ±3%, or within ±1%. However, with respect to the height H of the cone structure 31, a larger difference may be caused by shrinkage of the second part 5 or gravity. The size of the cone structure 31 refers to that immediately after releasing the liner 71, for example, within 5 minutes or within 3 minutes.

### (Liner Producing Step)

Next, as illustrated in FIGS. 9(a) to 9(c), the mold 61 is pressed against the liner 71, and the fine structure 61b of the surface 61a of the mold 61 is transferred to the liner 71. The material of a liner 71 is a material that is capable of transferring and retaining the fine structure 61b. An example of a liner 71 includes a sheet 71a in which a resin is laminated on a surface of a sheet body made from resin or paper, and a release coating 71b provided on the surface of the sheet 71a. The release coating 71b is made of silicone, for example. The transfer of the fine structure 61b can be achieved by, for example, applying the mold 61 to the surface (the release coating 71b) of the surface of the liner 71, followed by heat pressing of the liner 71. The transfer forms a fine structure 72 that is complementary to the fine structure 61b of the mold 61 on the surface of the liner 71. The fine structure 72 includes a plurality of recesses 72a having a cone structure.

### (First Part Forming Step)

Next, as illustrated in FIGS. 10(a) to 10(d), the first part 4 is formed by applying a solution including a non-adhesive or weak adhesive material to the fine structure 72 of the liner 71 and then solidifying it.

First, as illustrated in FIG. 10(a), a solution 81 including a non-adhesive or weak adhesive material is applied to the fine structure 72 formed in the surface of the liner 71 by coating, spraying or the like.

Next, as illustrated in FIG. 10(b), the excess solution 81 is scraped off by a removal device 82 such as a doctor blade or a squeegee. The removal device 82 moves in a direction A along the surface of the liner 71. As a result, as illustrated in FIG. 10(c), the solution 81 is reserved in the recesses 72a formed in the surface of the liner 71. In the fine structure 72 formed on the surface of the liner 71, the recesses 72a are preferably in proximity with each other, thereby making it easy to scrape off the solution 81. Next, as illustrated in FIG. 10(d), the solution 81 in the recess 72a is dried to remove a solvent to form the first part 4 in the recess 72a. The first part 4 is disposed at the bottom of each recess 72a and is made from a solid non-adhesive or weak adhesive material. After drying, an ultraviolet ray, an electron beam, or the like may be emitted to the first part 4 to cure the non-adhesive or weak adhesive material as necessary. In an embodiment, as illustrated in FIG. 10(d), the first part 4 occupies a space from a lowermost portion to a middle of the recess 72a, and includes, in an upper portion, a surface substantially parallel to the horizontal plane determined by the placement of the liner 71 during drying. In the mold 61 used in producing the liner 71, when an angle 0 formed between the side surface and the bottom surface of the cone structure 61c is large, or when a distance between the bottom surfaces of the cone structures 61c is small, it is easy to drop the solution 81 containing the non-adhesive or weak adhesive material to the bottom of the recess 72a. As a result, the first part 4 is easily formed. The solution 81 is made by dissolving and/or dispersing a resin such as polyurethane, poly (meth)acrylate, cellulose, silicone, an amine-based resin, a fluorine-based resin, or polyvinyl chloride in an appropriate solvent. The solvent used in the solution 81 may also affect the above-described scraping off of the solution 81. For example, when a solvent such as ethyl acetate, methyl ethyl ketone, methyl isobutyl ketone, or the like is used, the bottom surfaces of the cone structures 61c in the mold 61 are preferably proximity to each other (for example 50 μm or less).

### (Second Part Forming Step)

Next, as illustrated in FIG. 11(a), a strong adhesive material or its precursor is applied to the liner 71 in which the first part 4 is formed to form a second part 5. In the present embodiment, the adhesive layer 12 including the second part 5 and the base 32 is formed on the liner 71. When any other part is present between the first part 4 and the second part 5, the second part 5 is formed after the formation of the first part 4 and then the formation of the any other part. The application of the strong adhesive material can be performed by a variety of methods. For example, a strong adhesive material previously molded into a sheet or the like is applied to a fine structure 72 of the liner 71, and left at rest under heat and/or pressure, or at normal temperature and normal pressure for a certain time or more. Thus, the strong adhesive material flows and enters the recess 72a in the surface of the liner 71, and is joined to the first part 4 located at the bottom of the recess 72a. Alternatively, in another example, a precursor to be cured by irradiation with an energy ray such as an ultraviolet ray or an electron beam to become a strong adhesive material is applied to the fine structure 72 of the liner 71 to enter the recess 72a, and then is irradiated with the energy ray. In another example, a solution of a strong adhesive material is applied to the fine structure 72 of the liner 71 to enter the recess 72a, then heated as necessary, and dried to remove the solvent.

### (Carrier Forming Step)

Next, as illustrated in FIGS. 11(b) to 11(c), the carrier 102 such as a PVC film is formed on the adhesive layer 12. The carrier 102 is laminated onto the adhesive layer 12, for example, using a roller 103.

Through the steps described above, the adhesive sheet 110 of FIG. 3 can be produced. After forming the second part 5 as illustrated in FIG. 11(a), the liner 71 may be peeled from the adhesive layer 12 without forming the carrier 102. In this case, the adhesive sheet 10 in FIGS. 1 and 2 can be manufactured. Furthermore, when forming the second part 5, a pair of liners 71 (see FIG. 10(d)) in which the first part 4 remains in the recess 72a may be prepared, and a strong adhesive material or precursor thereof may be disposed between the pair of liners 71. In this case, the adhesive sheet 210 of FIG. 4 can be produced. Furthermore, by changing the shape of the fine structure 61b of the mold 61, the adhesive sheet 310 in FIG. 5 can be produced in the same manner as described above.

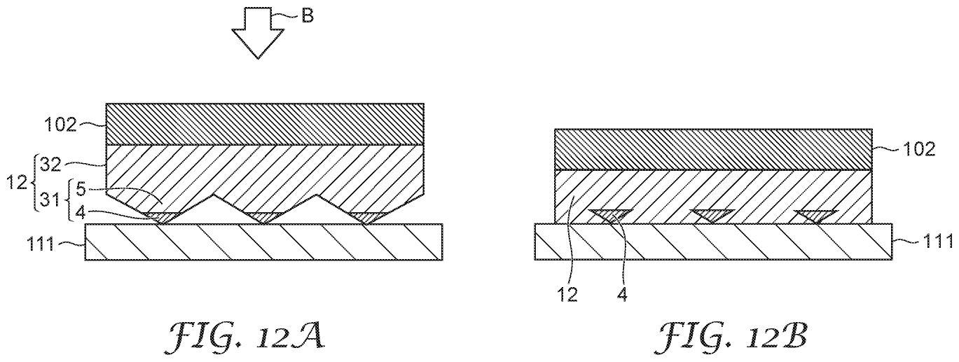

FIG. 12 are cross-sectional views illustrating a step of applying the adhesive sheet 110 in FIG. 3 to an adherend. First, as illustrated in FIG. 12(a), the liner 71 is removed from the adhesive sheet 110, and the adhesive sheet 110 is placed on an adherend 111 such that the first part 4 of the adhesive layer 12 faces the adherend 111. The adherend 111 may be, for example, a plate-like member such as a glass plate. While a pressure (arrow B) applied to the adhesive layer 12 is low, the first parts 4 support the adhesive layer 12 and the second parts 5 do not contact the adherend 111 at all or contact the adherend 111 only slightly. This allows the adhesive layer 12 to have slidability under low pressure.

On the other hand, as illustrated in FIG. 12(b), when a pressure above of a certain level or more is applied, for example, the second part 5 itself or the first part 4 deforms, or the first part 4 is incorporated into the second part 5, and thus the second part 5 comes into contact with the adherend 111. As a result, the adhesive layer 12 exhibits an adhesive force to the adherend 111.

Similarly, the adhesive sheets 10, 210, 310 may be slid relative to the adherend 111 and adhered to the adherend 111.

### EXAMPLES

The present disclosure will be described in details below with reference to examples, but the present disclosure is not intended to be limited to the examples.

### Example 1

A mold (mold ID: G) including a plurality of uniformly disposed square cone structures was produced by machining a metal flat plate using a diamond cutter. An angle formed between the bottom surface and the side surface of the square cone (corresponding to θ in FIG. 5) was 29 degrees, a distance between the bottom surfaces of adjacent square cones (corresponding to β in FIG. 5) was 0, a distance between apexes of adjacent square cones (corresponding to b in FIG. 5) was 91 μm, and a height of the square cone (corresponding to H in FIG. 5) was 25 μm. A pitch between adjacent square cones (corresponding to α+β in FIG. 5) is the same 91 μm as the distance between the apexes of adjacent square cones. Note that the size of the square cone was measured by observing a surface of the mold by using a high precision microscope, and selecting one square cone structure that can be imaged most clearly.

Next, a layer made of polyethylene (PE) was provided on each surface of a sheet made of polyethylene terephthalate (PET), and one of the PE layers was coated with silicone to prepare a base liner having a release surface. A mold was brought into contact with the release surface of the base liner, and the fine structure of the mold was transferred to the base liner by heat pressing to produce a liner including a fine structure. The fine structure on the liner had substantially the same size as the fine structure of the mold.

Next, an aqueous polyurethane solution (PUR-1: a solution composed mainly of Resamine D-6260 (Dainichiseika Color Co., Ltd.) and containing water, isopropanol, and NMP) was applied to the fine structure surface of the liner, and then excess solution was scraped off using a doctor blade or a squeegee. Solid content of the solution was 5%. The liner was heated in an oven at 80 to 100° C. to volatilize water, alcohol, other organic solvent, or a solvent including a mixture thereof in the solution, such that a solid urethane resin (corresponding to the first part) was disposed at the bottom of the square cone structure of the liner. Given that a height of the square cone structure was 100%, a height of the urethane resin was 20% of the height of the square cone structure. The area of the urethane resin projected on the surface orthogonal to the height direction of the square cone structure was 174 μm².

Next, a UV curable acrylic foam adhesive precursor was applied onto the fine structure of the liner. A base material of the UV curable acrylic foam precursor consisted of 93 mass % of 2-ethylhexyl acrylate and 7 mass % of acrylic acid based on the total mass of the base material. The UV curable acrylic foam adhesive precursor also contained 5 mass % of inorganic filler, based on the total mass of the base material. Thereafter, a carrier was laid over so as to generate a gap of approximately 0.4 mm between the carrier and the liner. UV irradiation was performed from above the carrier to cure the acrylic foam precursor. The cured acrylic foam is configured of a portion (corresponding to the second part) located in the square cone structure of the liner and a base that supports the second part. A thickness of the adhesive layer formed from the urethane resin and the acrylic foam was 400 μm.

The adhesive sheet in Example 1 was produced as described above.

### Example 2

An adhesive sheet in Example 2 was produced in the same manner as in Example 1 except that when the first part was formed, an aqueous polyurethane solution with solid content of 10% is used to set the height of the solid urethane resin to 24% of the height of the square cone structure, and the area of the urethane resin projected on the surface orthogonal to the height direction of the square cone structure to 484 μm².

### Example 3

An adhesive sheet in Example 3 was produced in the same manner as in Example 1 except that when the first part was formed, an aqueous polyurethane solution with solid content of 15% is used to set the height of the solid urethane resin to 27% of the height of the square cone structure, and the area of the urethane resin projected on the surface orthogonal to the height direction of the square cone structure to 625 μm².

### Example 4

An adhesive sheet in Example 4 was produced in the same manner as in Example 1 except that when the first part was formed, an aqueous polyurethane solution with solid content of 30% is used to set the height of the solid urethane resin to 47% of the height of the square cone structure, and the area of the urethane resin projected on the surface orthogonal to the height direction of the square cone structure to 1866 μm².

### Example 5

An adhesive sheet in Example 5 was produced in the same manner as in Example 1 except that when the second part was formed, a base material consisting of 92 mass % of 2-ethylhexyl acrylate and 8 mass % of acrylic acid was used based on the total mass of the base material.

### Example 6

An adhesive sheet in Example 6 was produced in the same manner as in Example 2 except that when the second part was formed, a base material consisting of 92 mass % of 2-ethylhexyl acrylate and 8 mass % of acrylic acid was used based on the total mass of the base material.

### Example 7

An adhesive sheet in Example 5 was produced in the same manner as in Example 1 except that when the second part was formed, a base material consisting of 90 mass % of 2-ethylhexyl acrylate and 10 mass % of acrylic acid was used based on the total mass of the base material.

### Example 8

An adhesive sheet in Example 6 was produced in the same manner as in Example 2 except that when the second part was formed, a base material consisting of 90 mass % of 2-ethylhexyl acrylate and 10 mass % of acrylic acid was used based on the total mass of the base material.

### Example 9

A mold (type ID: F) was produced in the same manner as in Example 1 except that the angle formed between the bottom surface and the side surface of the square cone (corresponding to θ in FIG. 5) was 28 degrees, the distance between the apexes of adjacent square cones (corresponding to b in FIG. 5) was 45 μm, and the height of the square cone (corresponding to H in FIG. 5) was 12 μm.

Next, a liner was prepared in the same manner as in Example 1.

Next, the first part was formed in the same manner as in Example 1 except that an aqueous polyurethane solution with solid content of 23% is used to set the height of the solid urethane resin to 40% of the height of the square cone structure, and the area of the urethane resin projected on the surface orthogonal to the height direction of the square cone structure to 331 μm².

Then, an acrylic foam was formed in the same manner as in Example 1 except that a UV curable acrylic foam adhesive precursor including a base material consisting of 92 mass % of 2-ethylhexyl acrylate and 8 mass % acrylic acid based on the total mass of the base material, and no inorganic filler was used, and the thickness of the adhesive layer formed from the urethane resin and the acrylic foam was set to 200 μm.

The adhesive sheet in Example 9 was produced as described above.

### Example 10

An adhesive sheet in Example 10 was produced in the same manner as in Example 9 except that when the first part was formed, an aqueous polyurethane solution with solid content of 15% is used to set the height of the solid urethane resin to 35% of the height of the square cone structure, and the area of the urethane resin projected on the surface orthogonal to the height direction of the square cone structure to 243 μm².

### Example 11

An adhesive sheet in Example 11 was produced in the same manner as in Example 9 except that when the first part was formed, an aqueous polyurethane solution with solid content of 5% is used to set the height of the solid urethane resin to 24% of the height of the square cone structure, and the area of the urethane resin projected on the surface orthogonal to the height direction of the square cone structure to 112 μm².

### Example 12

An adhesive sheet in Example 12 was produced in the same manner as in Example 9 except that when the first part was formed, an aqueous polyurethane solution with solid content of 0.5% is used to set the height of the solid urethane resin to 11% of the height of the square cone structure, and the area of the urethane resin projected on the surface orthogonal to the height direction of the square cone structure to 25 μm².

### Example 13

An adhesive sheet in Example 13 was produced in the same manner as in Example 9 except that when the first part was formed, an aqueous polyurethane solution with solid content of 30% is used to set the height of the solid urethane resin to 44% of the height of the square cone structure, and the area of the urethane resin projected on the surface orthogonal to the height direction of the square cone structure to 384 μm².

### Example 14

An adhesive sheet in Example 14 was produced in the same manner as in Example 13 except that when the first part was formed, an urethane resin with a different hardness was used.

### Example 15

An adhesive sheet in Example 15 was produced in the same manner as in Example 13 except that when the first part was formed, an urethane resin with a different hardness than the hardness of the urethane resin in Examples 13 and 14 was used.

### Example 16

An adhesive sheet in Example 16 was produced in the same manner as in Example 13 except that when the mold in Example 1 (mold ID: G) instead of the mold in Example 13 (mold ID: F) is used to form the first part, the height of the solid urethane resin was set to 47% of the height of the square cone structure, and the area of the urethane resin projected on the surface orthogonal to the height direction of the square cone structure was set to 1866 μm².

### Example 17

An adhesive sheet in Example 17 was produced in the same manner as in Example 16 except that when the first part was formed, an aqueous polyurethane solution with solid content of 23% is used to set the height of the solid urethane resin to 41% of the height of the square cone structure, and the area of the urethane resin projected on the surface orthogonal to the height direction of the square cone structure to 1436 μm².

### Example 18

An adhesive sheet in Example 18 was produced in the same manner as in Example 16 except that when the first part was formed, an aqueous polyurethane solution with solid content of 15% is used to set the height of the solid urethane resin to 27% of the height of the square cone structure, and the area of the urethane resin projected on the surface orthogonal to the height direction of the square cone structure to 625 μm².

### Example 19

An adhesive sheet in Example 19 was produced in the same manner as in Example 16 except that when the first part is formed, an aqueous polyurethane solution with solid content of 5% is used to set the height of the solid urethane resin to 20% of the height of the square cone structure, and the area of the urethane resin projected on the surface orthogonal to the height direction of the square cone structure to 324 μm².

### Example 20

An adhesive sheet in Example 20 was produced in the same manner as in Example 16 except that when the first part is formed, an aqueous polyurethane solution with solid content of 0.5% is used to set the height of the solid urethane resin to 14% of the height of the square cone structure, and the area of the urethane resin projected on the surface orthogonal to the height direction of the square cone structure to 174 μm².

### Example 21

An adhesive sheet in Example 21 was produced in the same manner as in Example 15 except that the mold in Example 1 (mold ID: G) was used instead of the mold in Example 13 (mold ID: F).

### Example 22

An adhesive sheet in Example 22 was produced in the same manner as in Example 13 except that the mold in Example 1 (mold ID: G) was used instead of the mold in Example 13 (mold ID: F) and when the second part was formed, a base material consisting of 93 mass % of 2-ethylhexyl acrylate and 7 mass % acrylic acid was used based on the total mass of the base material.

### Example 23

An adhesive sheet in Example 23 was produced in the same manner as in Example 18 except that when the second part was formed, a base material consisting of 90 mass % of 2-ethylhexyl acrylate and 10 mass % of acrylic acid was used based on the total mass of the base material.

### Example 24

An adhesive sheet in Example 24 was produced in the same manner as in Example 23 except that when the second part was formed, the thickness of the adhesive layer formed from the urethane resin and the acrylic foam was set to 400 μm.

### Example 25

An adhesive sheet in Example 25 was produced in the same manner as in Example 23 except that when the second part was formed, a base material consisting of 87.5 mass % of 2-ethylhexyl acrylate and 12.5 mass % of acrylic acid was used based on the total mass of the base material.

### Example 26

An adhesive sheet in Example 26 was produced in the same manner as in Example 25 except that when the second part was formed, the thickness of the adhesive layer formed from the urethane resin and the acrylic foam was set to 400 μm.

### Example 27

An adhesive sheet in Example 27 was produced in the same manner as in Example 24 except that when the second part was formed, the ratio of the content of the inorganic filler in the UV curable acrylic foam adhesive precursor was set to 8 mass % based on the total mass of the base material.

### Example 28

An adhesive sheet in Example 28 was produced in the same manner as in Example 27 except that when the second part was formed, the ratio of the content of the inorganic filler in the UV curable acrylic foam adhesive precursor was set to 5 mass % based on the total mass of the base material.

### Example 29

An adhesive sheet in Example 29 was produced in the same manner as in Example 27 except that when the second part was formed, the ratio of the content of the inorganic filler in the UV curable acrylic foam adhesive precursor was set to 7 mass % based on the total mass of the base material.

### Example 30

A mold (mold ID: C) including a plurality of uniformly disposed square cone structures was produced by machining a resin flat plate by laser machining. The angle between the bottom surface and the side surface of the square cone (corresponding to β in FIG. 5) was 49 degrees, the distance between the bottom surfaces of adjacent square cones (corresponding to β in FIG. 5) was 7 μm, the distance between apexes of adjacent square cones (corresponding to b in FIG. 5) was 36 μm, the pitch between adjacent square cones (corresponding to α+β in FIG. 5) was 45 μm, and the height of the square cone (corresponding to H in FIG. 5) was 17 μm. Note that the size of the square cone was measured by observing a surface of the mold by using a high precision microscope, and selecting one square cone structure that can be imaged most clearly.

Next, a liner was prepared in the same manner as in Example 1.

Next, the first part was formed in the same manner as in Example 1 except that an aqueous polyurethane solution with solid content of 30% is used to set the height of the solid urethane resin to 43% of the height of the square cone structure, and the area of the urethane resin projected on the surface orthogonal to the height direction of the square cone structure to 369 μm².

Next, an acrylic foam was formed in the same manner as in Example 1 except that a base material containing 92 mass % of 2-ethylhexyl acrylate and 8 mass % of acrylic acid was used based on the total mass of the base material.

The adhesive sheet in Example 30 was produced as described above. In the adhesive sheet in Example 30, the value of β/(α+β) was 0.16 because (α+β) was 45 μm and β was 7 μm.

### Reference Example 1

A UV curable acrylic foam adhesive precursor was applied on a smooth liner (PET) having no fine structure on the surface. A base material of the UV curable acrylic foam precursor consists of 92 mass % of 2-ethylhexyl acrylate and 8 mass % of acrylic acid based on the total mass of the base material. The UV curable acrylic foam precursor does not include an inorganic filler. Thereafter, a carrier was laid over so as to generate a gap of approximately 0.2 mm between the carrier and the liner. UV irradiation was performed from above the carrier to cure the acrylic foam precursor. The thickness of the cured acrylic foam was 200 μm.

The adhesive sheet in Reference Example 1 was produced as described above.

### Reference Example 2

A UV curable acrylic foam adhesive precursor was applied onto a liner (paper) in which hollow glass microspheres were disposed in an emboss. A base material of the UV curable acrylic foam precursor consists of 92 mass % of 2-ethylhexyl acrylate and 8 mass % of acrylic acid based on the total mass of the base material. The UV curable acrylic foam adhesive precursor contains 5% by mass of inorganic filler based on the total mass of the base material. Thereafter, a carrier was laid over so as to generate a gap of approximately 2 mm between the carrier and the liner. UV irradiation was performed from above the carrier to cure the acrylic foam precursor. The thickness of the cured acrylic foam was 200

The adhesive sheet in Reference Example 2 was produced as described above.

### Reference Example 3

A UV curable acrylic foam adhesive precursor was applied to a liner (paper) on which grid-like protrusions were formed on the surface. A base material of the UV curable acrylic foam precursor consists of 92 mass % of 2-ethylhexyl acrylate and 8 mass % of acrylic acid based on the total mass of the base material. The UV curable acrylic foam adhesive precursor contains 5% by mass of inorganic filler based on the total mass of the base material. Thereafter, a carrier was laid over so as to generate a gap of approximately 2 mm between the carrier and the liner. UV irradiation was performed from above the carrier to cure the acrylic foam precursor. A thickness of the cured acrylic foam was 400 μm.

The adhesive sheet in Reference Example 3 was produced as described above.

### Reference Example 4

A UV curable acrylic foam adhesive precursor was applied to a liner (paper) on which lattice-like protrusions were formed on the surface, and hollow glass microspheres were disposed in the emboss. A base material of the UV curable acrylic foam precursor consists of 92 mass % of 2-ethylhexyl acrylate and 8 mass % of acrylic acid based on the total mass of the base material. The UV curable acrylic foam adhesive precursor contains 5% by mass of inorganic filler based on the total mass of the base material. Thereafter, a carrier was laid over so as to generate a gap of approximately 0.4 mm between the carrier and the liner. UV irradiation was performed from above the carrier to cure the acrylic foam precursor. A thickness of the cured acrylic foam was 400 μm. Note that the Inventor does not recognize that Reference Example 4 is a known technology, and presents a sample combining Reference Examples 2 and 3 as a reference.

The adhesive sheet in Reference Example 4 was produced as described above. The configurations of the adhesive sheets in the examples and reference examples described above are summarized in Tables 1 and 2.

TABLE 1

| | First part | | | | Second part | | Adhesive | | |
|---|---|---|---|---|---|---|---|---|---|
| | | Solid | | | | Inorganic | layer | Mold | |
| | | content of | Height | Projected | | filler | Thickness | Mold | Liner |
| | Material | solution (%) | (%) | Area (μm²) | Base Material | (mass %) | (mm) | ID | Material |
| Example 1 | Urethane | 5 | 20 | 174 | 2EHA/AA = 93/7 | 5 | 0.4 | G | PET |
| Example 2 | Urethane | 10 | 24 | 484 | 2EHA/AA = 93/7 | 5 | 0.4 | G | PET |
| Example 3 | Urethane | 15 | 27 | 625 | 2EHA/AA = 93/7 | 5 | 0.4 | G | PET |
| Example 4 | Urethane | 30 | 47 | 1866 | 2EHA/AA = 93/7 | 5 | 0.4 | G | PET |
| Example 5 | Urethane | 5 | 20 | 174 | 2EHA/AA = 92/8 | 5 | 0.4 | G | PET |
| Example 6 | Urethane | 10 | 24 | 484 | 2EHA/AA = 92/8 | 5 | 0.4 | G | PET |
| Example 7 | Urethane | 5 | 20 | 174 | 2EHA/AA = 90/10 | 5 | 0.4 | G | PET |
| Example 8 | Urethane | 10 | 24 | 484 | 2EHA/AA = 90/10 | 5 | 0.4 | G | PET |
| Example 9 | Urethane | 23 | 40 | 331 | 2EHA/AA = 92/8 | Not | 0.2 | F | PET |
| | | | | | | observed | | | |
| Example 10 | Urethane | 15 | 35 | 243 | 2EHA/AA = 92/8 | Not | 0.2 | F | PET |
| | | | | | | observed | | | |
| Example 11 | Urethane | 5 | 24 | 112 | 2EHA/AA = 92/8 | Not | 0.2 | F | PET |
| | | | | | | observed | | | |
| Example 12 | Urethane | 0.5 | 11 | 25 | 2EHA/AA = 92/8 | Not | 0.2 | F | PET |
| | | | | | | observed | | | |
| Example 13 | Urethane | 30 | 44 | 384 | 2EHA/AA = 92/8 | Not | 0.2 | F | PET |
| | | | | | | observed | | | |
| Example 14 | Urethane | 30 | 44 | 384 | 2EHA/AA = 92/8 | Not | 0.2 | F | PET |
| | | | | | | observed | | | |
| Example 15 | Urethane | 30 | 44 | 384 | 2EHA/AA = 92/8 | Not | 0.2 | F | PET |
| | | | | | | observed | | | |

TABLE 2

| | First part | | | | Second part | | Adhesive | | |
|---|---|---|---|---|---|---|---|---|---|
| | | Solid | | | | Inorganic | layer | Mold | |
| | | content of | Height | Projected | | filler | Thickness | Mold | Liner |
| | Material | solution (%) | (%) | Area (μm²) | Base Material | (mass %) | (mm) | ID | Material |
| Example 16 | Urethane | 30 | 47 | 1866 | 2EHA/AA = 92/8 | Not | 0.2 | G | PET |
| | | | | | | observed | | | |
| Example 17 | Urethane | 23 | 41 | 1436 | 2EHA/AA = 92/8 | Not | 0.2 | G | PET |
| | | | | | | observed | | | |
| Example 18 | Urethane | 15 | 27 | 625 | 2EHA/AA = 92/8 | Not | 0.2 | G | PET |
| | | | | | | observed | | | |
| Example 19 | Urethane | 5 | 20 | 324 | 2EHA/AA = 92/8 | Not | 0.2 | G | PET |
| | | | | | | observed | | | |
| Example 20 | Urethane | 0.5 | 14 | 174 | 2EHA/AA = 92/8 | Not | 0.2 | G | PET |
| | | | | | | observed | | | |
| Example 21 | Urethane | 30 | 44 | 384 | 2EHA/AA = 92/8 | Not | 0.2 | G | PET |
| | | | | | | observed | | | |
| Example 22 | Urethane | 30 | 44 | 384 | 2EHA/AA = 93/7 | Not | 0.2 | G | PET |
| | | | | | | observed | | | |
| Example 23 | Urethane | 15 | 27 | 625 | 2EHA/AA = 90/10 | Not | 0.2 | G | PET |
| | | | | | | observed | | | |
| Example 24 | Urethane | 15 | 27 | 625 | 2EHA/AA = 90/10 | Not | 0.4 | G | PET |
| | | | | | | observed | | | |
| Example 25 | Urethane | 15 | 27 | 625 | 2EHA/AA = 87.5/12.5 | Not | 0.2 | G | PET |
| | | | | | | observed | | | |
| Example 26 | Urethane | 15 | 27 | 625 | 2EHA/AA = 87.5/12.5 | Not | 0.4 | G | PET |
| | | | | | | observed | | | |
| Example 27 | Urethane | 15 | 27 | 625 | 2EHA/AA = 90/10 | 8 | 0.4 | G | PET |
| Example 28 | Urethane | 15 | 27 | 625 | 2EHA/AA = 90/10 | 5 | 0.4 | G | PET |
| Example 29 | Urethane | 15 | 27 | 625 | 2EHA/AA = 90/10 | 7 | 0.4 | G | PET |
| Example 30 | Urethane | 30 | 43 | 369 | 2EHA/AA = 92/8 | 5 | 0.4 | C | PET |
| Reference | | | | | 2EHA/AA = 92/8 | Not | 0.2 | — | PET |
| Example 1 | | | | | | observed | | | |
| Reference | | | | | 2EHA/AA = 92/8 | 5 | 0.2 | | Paper |
| Example 2 | | | | | | | | | |
| Reference | | | | | 2EHA/AA = 92/8 | 5 | 0.4 | | Paper |
| Example 3 | | | | | | | | | |
| Reference | | | | | 2EHA/AA = 92/8 | 5 | 0.4 | | Paper |
| Example 4 | | | | | | | | | |

### (Evaluation Results)

The adhesive sheets in Example 1 to 30 and Reference Examples 1 to 4 were evaluated as follows.

### (Slidability Before Crimping)

Each of the adhesive sheets was cut to a size of approximately 2.5 cm×approximately 7.5 cm, and the liner was peeled off to produce a sample. With one end of the obtained sample grasped, the sample was placed on a horizontally disposed flat glass plate while being hung such that a pressure-sensitive adhesive surface came into contact with the glass plate. After this state was maintained for approximately 10 seconds, the end of the sample was lifted and pulled horizontally. Behavior at that time was evaluated according to the following criteria, and it was determined that the sample achieving a score of 1 or more had slidability.

3: Sample slides freely

2: Sample has some resistance, but slides easily

1: Sample has a strong resistance, but can slide slide

0: Sample cannot slide

### (Static Friction Coefficient)

The static friction coefficient of each adhesive sheet was measured in accordance with JIS K 7125, except that a metal slip piece such as steel material (for example, SS400 material that may be plated with chrome or the like) was pulled at a rate of 1000 mm/min. Each of the adhesive sheets was cut to a width of 80 mm and a length of 150 mm to prepare a sample. The sample was placed on a table of a slip/peel tester (TSH-1202-50N, IMASS) such that a pressure-sensitive adhesive surface was placed upward, and a plate-like steel material of 40 cm² was directly placed thereon as a 200 g slip piece. The slip piece was pulled at a rate of 1000 mm/min, and static friction force (F₂) was measured using a load cell. From measurement results, the static friction coefficient (μₛ) was calculated according to the following equation.

μₛ=Fₛ/F_{P}

Fₛ: Static frictional force (N)

F_{P}: normal force (N) (=1.96 N)

### (Slidability After Crimping)

Each of the adhesive sheets was cut to a size of approximately 2.5 cm×approximately 7.5 cm, and the liner was peeled off to produce a sample. With one end of the obtained sample grasped, the sample was placed on a horizontally disposed flat glass plate while being hung such that a pressure-sensitive adhesive surface came into contact with the glass plate. Next, using a crimping device stipulated in 10.2.4 of JIS Z 0237: 2009, the sample was crimped onto the glass plate by reciprocating the 2 kg roller once at a rate of 300 mm/min. After this state was maintained for approximately 10 seconds, the end of the sample was lifted and pulled horizontally. The behavior at that time was evaluated based on the same criteria as described above for slidability before crimping.

### (90-Degree Peel Strength)

The 90-degree peel strength of each adhesive sheet was measured in accordance with JIS Z 0237: 2009. Each of the adhesive sheets was cut to a width of 10 mm and a length of 100 mm to prepare a sample. The sample was crimped onto the plate using a squeegee such that the pressure-sensitive adhesive surface came into contact with the SUS plate. After the sample was left at rest for 24 hours, a 90 degree peeling test was performed under conditions of a temperature of 23° C. and a tensile speed of 300 mm/min.

### (Retention Time)

The retention time of each adhesive sheet was measured in the holding power test according to JIS Z 0237: 2009. Each of the adhesive sheet was cut to a width of 12 mm and a length of 25 mm, the liner and the carrier were peeled, and a 0.82 g SUS plate (SUS304BA having a width of 30 mm, a length of 60 mm, and a thickness of 0.5 mm) was attached to each surface of the adhesive layer to prepare a sample. With the sample placed horizontally, a 1 kg weight was placed on the sample and the sample was left for 15 minutes. Next, in the state where the sample was vertically erected, one SUS plate (SUS plate attached to one surface of the adhesive layer on which the fine structure was provided) was fixed. The sample was left in this state under an atmosphere of 90 ° C. for 10 minutes. Next, a 1 kg weight was vertically hung from the other SUS plate. A time taken from hanging of the weight to falling of the SUS plate with the weight was measured. A similar measurement was performed three times, and an average time was defined as the retention time.

### (Air Releasability)

Each of the adhesive sheets was cut to a size of approximately 2.5 cm×approximately 7.5 cm, and the liner was peeled off to produce a sample. With one end of the obtained sample grasped, the sample was placed on a horizontally disposed flat glass plate while being hung such that a pressure-sensitive adhesive surface came into contact with the glass plate. After this state was maintained for approximately 10 seconds, each end of the sample was pressed from above with a pressure of approximately 500 g, and the edge of the sample (the region within approximately 0.5 cm from the end) was uniformly brought into contacted with the glass plate. Subsequently, a pressure was applied by with a finger from the edge toward the center of the sample, thereby preventing peeling of the sample or movement of the entire air pocket toward the end. The bubbles captured in the sample were visually observed in this state.

Evaluation results are illustrated in Tables 3 to 4.

TABLE 3

| | | Static | Static | | | 90-degree | | |
|---|---|---|---|---|---|---|---|---|
| | Slidability | friction | friction | Static | Slidability | peel | Retention | |
| | (before | force | force | friction | (after | strength | Time | Air |
| | crimping) | (N) | (N/cm²) | coefficient | crimping) | (N/10 mm) | (min) | releasability |
| Example 1 | 3 | 9.3 | 0.23 | 4.7 | 0 | 11.8 | 5000 min | No bubbles |
| | | | | | | | or more | |
| Example 2 | 3 | 8 | 0.20 | 4.1 | 0 | 12.8 | 5000 min | No bubbles |
| | | | | | | | or more | |
| Example 3 | 3 | 6.5 | 0.16 | 3.3 | 0 | 11.2 | 5000 min | No bubbles |
| | | | | | | | or more | |
| Example 4 | 3 | 4.9 | 0.12 | 2.5 | 0 | 8 | 5000 min | No bubbles |
| | | | | | | | or more | |
| Example 5 | 3 | — | — | — | 0 | 17.9 | 5000 min | No bubbles |
| | | | | | | | or more | |
| Example 6 | 3 | 6 | 0.15 | 3.1 | 0 | 9 | 5000 min | No bubbles |
| | | | | | | | or more | |
| Example 7 | 3 | — | — | — | 0 | 12.1 | 5000 min | No bubbles |
| | | | | | | | or more | |
| Example 8 | 3 | — | — | — | 0 | 12 | 5000 min | No bubbles |
| | | | | | | | or more | |
| Example 9 | 3 | 5.5 | 0.14 | 2.8 | 0 | 4.6 | 5000 min | No bubbles |
| | | | | | | | or more | |
| Example 10 | 3 | 8.9 | 0.22 | 4.5 | 0 | 6.8 | 5000 min | No bubbles |
| | | | | | | | or more | |
| Example 11 | 2 | 9.1 | 0.23 | 4.6 | 0 | 9.9 | 5000 min | No bubbles |
| | | | | | | | or more | |
| Example 12 | 1 | 13.8 | 0.35 | 7.0 | 0 | 12.9 | 5000 min | No bubbles |
| | | | | | | | or more | |
| Example 13 | 3 | 5.3 | 0.13 | 2.7 | 0 | 5.4 | 5000 min | No bubbles |
| | | | | | | | or more | |
| Example 14 | 3 | 5.6 | 0.14 | 2.9 | 0 | 9.7 | 5000 min | No bubbles |
| | | | | | | | or more | |
| Example 15 | 2 | 11.5 | 0.29 | 5.9 | 0 | 12.4 | 5000 min | No bubbles |
| | | | | | | | or more | |

TABLE 4

| | | Static | Static | | | 90-degree | | |
|---|---|---|---|---|---|---|---|---|
| | Slidability | friction | friction | Static | Slidability | peel | Retention | |
| | (before | force | force | friction | (after | strength | Time | Air |
| | crimping) | (N) | (N/cm²) | coefficient | crimping) | (N/10 mm) | (min) | releasability |
| Example 16 | 3 | 3.5 | 0.09 | 1.8 | 0 | 5.4 | 5000 min | No bubbles |
| | | | | | | | or more | |
| Example 17 | 3 | — | — | — | 0 | 5.4 | 5000 min | No bubbles |
| | | | | | | | or more | |
| Example 18 | 3 | — | — | — | 0 | 6.1 | 5000 min | No bubbles |
| | | | | | | | or more | |
| Example 19 | 2 | — | — | — | 0 | 5.9 | 5000 min | No bubbles |
| | | | | | | | or more | |
| Example 20 | 1 | — | — | — | 0 | 11.9 | 5000 min | No bubbles |
| | | | | | | | or more | |
| Example 21 | 2 | — | — | — | 0 | 8.4 | 5000 min | No bubbles |
| | | | | | | | or more | |
| Example 22 | 3 | — | — | — | 0 | 2.7 | 5000 min | No bubbles |
| | | | | | | | or more | |
| Example 23 | 3 | — | — | — | 0 | 5.7 | 5000 min | No bubbles |
| | | | | | | | or more | |
| Example 24 | 3 | — | — | — | 0 | 7.7 | 5000 min | No bubbles |
| | | | | | | | or more | |
| Example 25 | 3 | — | — | — | 0 | 8.5 | 5000 min | No bubbles |
| | | | | | | | or more | |
| Example 26 | 3 | — | — | — | 0 | 12 | 5000 min | No bubbles |
| | | | | | | | or more | |
| Example 27 | 3 | — | — | — | 0 | 11.8 | 5000 min | No bubbles |
| | | | | | | | or more | |
| Example 28 | 3 | — | — | — | 0 | 15.3 | 5000 min | No bubbles |
| | | | | | | | or more | |
| Example 29 | 3 | — | — | — | 0 | 13.9 | 5000 min | No bubbles |
| | | | | | | | or more | |
| Example 30 | 3 | — | — | — | 0 | 4.1 | 5000 min | No bubbles |
| | | | | | | | or more | |
| Reference | 0 | 50 or | 1.25 or | 25.5 or | 0 | 15.9 | 5000 min | No bubbles |
| Example 1 | | greater | greater | greater | | | or more | |
| Reference | 1 | — | — | — | 0 | 8.6 | — | No bubbles |
| Example 2 | | | | | | | | |
| Reference | 0 | 50 or | 1.25 or | 25.5 or | 0 | 8.9 | 5000 min | No bubbles |
| Example 3 | | greater | greater | greater | | | or more | |
| Reference | 1 | 50 or | 1.25 or | 25.5 or | 0 | 12.1 | 5000 min | No bubbles |
| Example 4 | | greater | greater | greater | | | or more | |

As illustrated in Table 3 and Table 4, the adhesive sheet in Examples 1 to 30 had high slidability before crimping, high holding power in the holding power test, and high air releasability.

### REFERENCE SIGNS LIST

1: Bottom surface, 2: Top part, 3: Side surface, 4: First part, 5: Second part, 10, 110, 210, 310: Adhesive sheet, 12, 112: Adhesive layer, 12a, 112a, 112b: Surface, 13: Fine structure. 31: Cone structure (convex structure), 71: Liner, 131: Truncated cone structure (convex structure).

1. An adhesive sheet including an adhesive layer with a fine structure on a surface of the adhesive layer; wherein
the fine structure includes a plurality of convex structures,
the convex structures each include two or more parts, a first part located at a top portion of the convex structure is made from a non-adhesive or weak adhesive material, and a second part located below the first part is made from a strong adhesive material, and
given that a width of a bottom surface of the convex structure is a and a distance between bottom surfaces of the adjacent convex structures is 13 in an arrangement direction of the convex structures, β/(α+β)<0.3 is satisfied.

2. The adhesive sheet according to claim 1, wherein a static friction coefficient as tested according to JIS K 7125 except that a metal slip piece is pulled at a rate of 1000 mm/min is 10 or less.

3. The adhesive sheet according to claim 1, wherein the two or more parts are joined to each other via an interface.

4. The adhesive sheet according to claim 1, wherein given that a height of the convex structure is 100%, a height of the first part is in a range of 10% to 90% of the height of the convex structure.

5. The adhesive sheet according to claim 1, wherein an angle θ formed between a side surface and a bottom surface of the convex structure is 5 degrees or greater.

6. The adhesive sheet according to claim 1, wherein a height of the convex structure is 5 μm or greater.

7. The adhesive sheet according to claim 1, further comprising a liner disposed on the fine structure.

8. The adhesive sheet according to claim 1, wherein in a holding power test on an adhesive surface having a width of 12 mm and a length of 25 mm in accordance with JIS Z 0237: 2009, a retention time is 5000 minutes or more.

9. The adhesive sheet according to claim 1, wherein the second part includes an acrylic foam.

10. The adhesive sheet according to claim 1, wherein the fine structure is provided on both surfaces of the adhesive layer.
